(19) United States
(12) Patent Application Publication
(10) Pub. No.: US 2017/0269350 A1
(43) Pub. Date: Sep. 21, 2017

(54) CIRCUIT AND METHOD FOR DRIVING ELECTROSTATIC MEMS

(71) Applicant: SILICON LIGHT MACHINES CORPORATION, Sunnyvale, CA (US)

(72) Inventors: Hyung KYU Lee, Seoul (KR); Alexander Payne, Ben Lomond, CA (US); Michael Yeung, Fremont, CA (US)

(73) Assignee: SILICON LIGHT MACHINES CORPORATION, Sunnyvale, CA (US)

(21) Appl. No.: 15/071,096

(22) Filed: Mar. 15, 2016

(51) Int. Cl. G02B 26/00; H02N 1/00

(52) U.S. Cl. CPC G02B 26/001; H02N 1/002

(57) ABSTRACT

A circuit and method for driving electrostatic microelectomechanical systems (MEMS) are provided. In one embodiment, the circuit includes a first electrode in a movable element of the MEMS and a second electrode on a surface of a substrate of the MEMS over which the movable element is suspended, and a driver electrically coupled to the first and the second electrodes. The driver supplies a voltage differential between the first and second electrodes to vary an electrostatic force between the electrodes thereby moving the movable element. The driver is configured to supply a voltage pulse having a leading edge in which a first voltage intermediate between an initial, minimum voltage and a maximum voltage is maintained for a first time before rising to the maximum voltage timed to dampen oscillations of the movable element. Other embodiments are also described.

### TECHNICAL FIELD

The present disclosure relates generally to the field of microelectomechanical systems (MEMS), and more particularly to a circuit or driver and method for driving electrostatic MEMS.

### BACKGROUND

Electrostatic MEMS devices generally include a movable member or actuator supported above a substrate towards which it can be moved by the application of electrostatic force between a first electrode in the actuator and a second electrode in or on the substrate underlying the actuator. One particular type of electrostatic MEMS, an optical MEMS, is widely used in display, print, lithographic and optical communication technologies. In operation, light reflected from an optically reflective surface formed on the actuator of the optical MEMS can constructively or destructively interfere with light reflected from another optically reflective surface formed on an adjacent actuator, or from a stationary optically reflective surface formed on or above the substrate.

One type of an optical MEMS is a grating light valve (GLV™), which includes a number of movable elastic ribbons and is capable of modulating light by constructive and destructive interference of an incident light source. Exemplary grating light valves and methods for making grating light valves are disclosed in the U.S. Pat. Nos. 5,311,360, 5,841,579 and 5,808,797, issued to Bloom et al., the contents of which are hereby incorporated by reference.

Another type of optical MEMS is a planar light valve (PLV™), which generally includes two films or membranes having light reflecting surfaces of equal area and reflectivity disposed above an upper surface of a substrate. The topmost film is a static tent membrane or member having a first optically reflective surface, and array of apertures through which a second optically reflective surface of the actuator is exposed on a movable membrane underneath. Exemplary planar light valves and methods for making planar light valves are disclosed in the U.S. Pat. No. 7,064,883, issued to Payne et al., the contents of which are hereby incorporated by reference.

Problems with conventional optical MEMS include ringing and overshoot, which can occur when the actuator is moved from an undeflected to a deflected state or from a deflected to an undeflected state by application of electrostatic force. By ringing it is meant an unwanted oscillation of the movable member as it first overshoots and then undershoots a target or desired position. To compensate for ringing and overshoot conventional optical MEMS the rate at which drive voltages are applied between the electrodes reduced and/or the actuators are encapsulated in a damping medium such as a gas. Unfortunately, both of these approaches increase the settling time or delay required for the actuator to settle at the target position.

Accordingly, there is a need for an improved circuit and method for driving electrostatic MEMS that will substantially reduce or eliminate ringing and overshoot associated with moving the actuator or movable member.

### SUMMARY

A circuit and method for driving an electrostatic microelectomechanical systems (MEMS) are provided.

In one embodiment, the circuit includes a first electrode in a movable element of the MEMS and a second electrode on a surface of a substrate of the MEMS over which the movable element is suspended, and a driver electrically coupled to the first and the second electrodes. The driver supplies a voltage differential between the first and second electrodes to vary an electrostatic force between the electrodes thereby moving the movable element. The driver is configured to supply a voltage pulse having a leading edge in which a first voltage intermediate between an initial, minimum voltage and a maximum voltage is maintained for a first time before rising to the maximum voltage timed to dampen oscillations of the movable element.

In another embodiment a method for driving an electrostatic MEMS includes generating a voltage pulse having a leading edge in which a first intermediate voltage between an initial, minimum voltage and a maximum voltage is maintained for a first time before rising to the maximum voltage, and coupling the voltage pulse to a first electrode in a MEMS and a second electrode on a surface of a substrate of the MEMS over which the movable element is suspended. A voltage differential between the first and second electrodes introduced by the voltage pulse varies an electrostatic force between the electrodes thereby moving the movable element, while the first intermediate voltage and first time for which it is maintained are selected to substantially prevent overshoot and dampen oscillations of the movable element.

### BRIEF DESCRIPTION OF THE DRAWINGS

Embodiments of the present invention will be understood more fully from the detailed description that follows and from the accompanying drawings and the appended claims provided below, where:

FIG. 1A is a perspective view of an electrostatic microelectomechanical systems (MEMS) based optical modulator;

FIGS. 1B and 1C are schematic cross-sectional views of a pixel of the optical modulator of FIG. 1A;

FIG. 2A is a schematic block diagram of another embodiment of a MEMS based optical modulator according to an embodiment of the present disclosure;

FIG. 2B is a schematic sectional side view of two adjacent modulators of the array of FIG. 2A;

FIG. 2C is a schematic block diagram of an actuator of a single modulator of the array of FIG. 2A;

FIG. 3 is a schematic sectional side view of an alternative embodiment of a single modulator of a MEMS based optical modulator according to an embodiment of the present disclosure;

FIG. 4A is a block diagram of a pulse shaping circuit according to an embodiment of the present disclosure;

FIG. 4B is a schematic diagram of an embodiment of the pulse shaping circuit of FIG. 4A;

FIGS. 4C and 4D are schematic diagrams of a portion of the sample and comparator of the pulse shaping circuit of FIG. 4B;

FIG. 4E are graphs of input pulse and an output pulse from the sample comparator of FIGS. 4C and 4D;

FIG. 5 is an idealized graph of a test pulse for determining step magnitude and step delay in an optimized shaped pulse according to an embodiment of the present disclosure;

FIG. 6 is a graph illustrating an intensity of reflection from a movable element in an electrostatic MEMS based optical modulator driven by a test pulse including a leading edge step of varying magnitude according to an embodiment of the present disclosure;

FIG. 7 is a graph illustrating an intensity of reflection from a movable element in an electrostatic MEMS based optical modulator driven by a test pulse including a leading edge step of varying delay according to an embodiment of the present disclosure;

FIG. 8 is a graph illustrating an intensity of reflection from a movable element in an electrostatic MEMS based optical modulator driven by a test pulse including a trailing edge step of varying magnitude according to an embodiment of the present disclosure;

FIG. 9 is a graph illustrating an intensity of reflection from a movable element in an electrostatic MEMS based optical modulator driven by a test pulse including a trailing edge step of varying delay according to an embodiment of the present disclosure;

FIG. 10 is an idealized graph of an optimized shaped pulse according to an embodiment of the present disclosure;

FIG. 11 is a graph of an optimized shaped pulse according to an embodiment of the present disclosure;

FIGS. 12A and 12B are graphs comparing an intensity of reflection from a movable element in an electrostatic MEMS based optical modulator driven by an optimized shaped pulse versus an non-shaped pulse;

FIGS. 13A and 13B are graphs illustrating the effects on rise and fall time of light reflected from a MEMS based optical modulator driven by an optimized shaped pulse according to an embodiment of the present disclosure versus an non-shaped pulse; and

FIG. 14 is a flowchart illustrating an embodiment of a method for driving an electrostatic MEMS using a shaped pulse.

### DETAILED DESCRIPTION

The present disclosure is directed generally to a circuit and method for driving an electrostatic microelectomechanical systems (MEMS) to substantially prevent overshoot and dampen oscillations of a movable element in the MEMS.

In the following description, numerous specific details are set forth, such as specific configurations, compositions, and processes, etc., in order to provide a thorough understanding of the present invention. In other instances, well-known processes and manufacturing techniques have not been described in particular detail in order to not unnecessarily obscure the present invention. Furthermore, it is to be understood that the various embodiments shown in the Figures are illustrative representations and are not necessarily drawn to scale.

The terms “above,” “over,” “between,” and “on” as used herein refer to a relative position of one layer with respect to other layers. One layer deposited or disposed above or under another layer may be directly in contact with the other layer or may have one or more intervening layers. One layer deposited or disposed between layers may be directly in contact with the layers or may have one or more intervening layers. In contrast, a first layer “on” a second layer is in contact with that second layer.

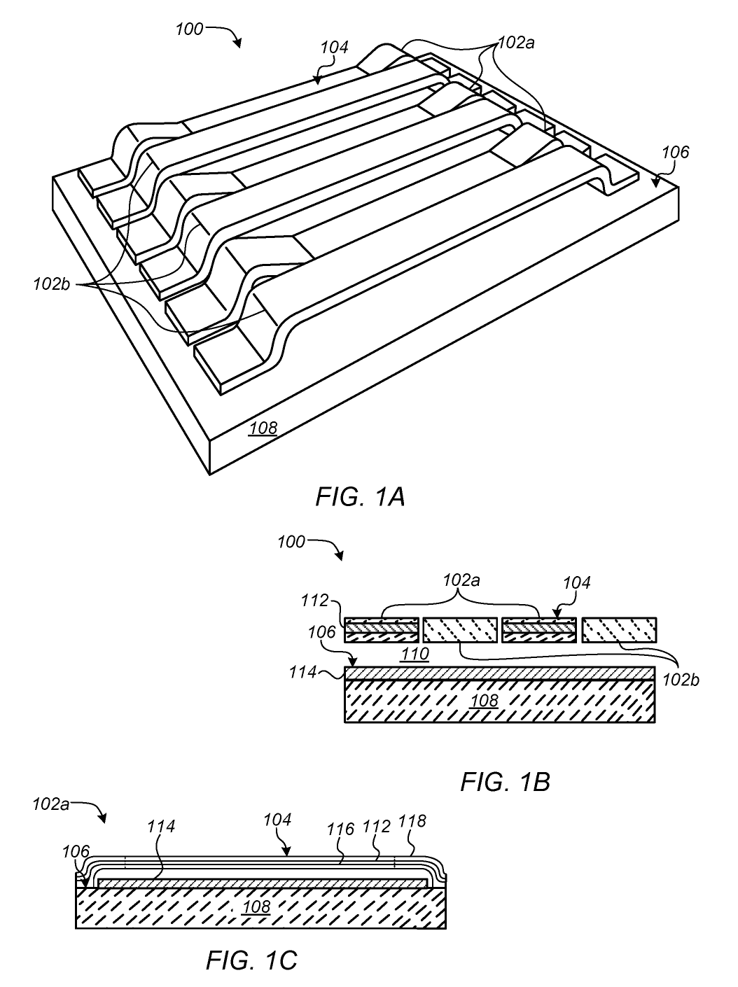

A ribbon-type optical modulator, such as a GLV™, including a number of dielectric mirrors or reflectors formed thereon to modulate a beam of light generated by a laser will now be described with reference to FIG. 1. For purposes of clarity, many of the details of MEMS in general and MEMS optical modulators in particular that are widely known and are not relevant to the present invention have been omitted from the following description. The drawings described are only schematic and are non-limiting. In the drawings, the size of some of the elements may be exaggerated and not drawn to scale for illustrative purposes. The dimensions and the relative dimensions may not correspond to actual reductions to practice of the invention.

Referring to FIGS. 1A and 1B, a ribbon-type optical modulator 100 generally includes a number of ribbons 102a, 102b; each having a light reflective surface 104 supported over a surface 106 of a substrate 108. One or more of the ribbons 102a are movable or deflectable through a gap or cavity 110 toward the substrate 108 to form an addressable diffraction grating with adjustable diffraction strength. The ribbons are 102a deflected towards the surface 106 of the substrate 108 by electrostatic forces generated when a voltage is applied between electrodes 112 in the deflectable ribbons 102a and base electrodes 114 formed in or on the substrate. The applied voltages are controlled by drive electronics (not shown in these figures), which may be integrally formed in or on the surface 106 of the substrate 108 below or adjacent to the ribbons 102. Light reflected from the movable ribbons 102a adds as vectors of magnitude and phase with that reflected from stationary ribbons 102b or a reflective portion of the surface 106 beneath the ribbons, thereby modulating light reflected from the optical modulator 100.

A schematic sectional side view of a movable structure or ribbon 102a of the optical modulator 100 of FIG. 1A taken along a longitudinal axis is shown in FIG. 1C. Referring to FIG. 1C, the ribbon 102a includes an elastic mechanical layer 116 to support the ribbon above the surface 106 of the substrate 108, an electrode or conducting layer 112 and the reflective surface 104 overlying the mechanical layer and conducting layer. As shown in FIG. 1C, the reflective surface 104 is formed on a separate dielectric mirror or reflector 118 discrete from and overlying the mechanical layer 116 and the conducting layer 112.

Generally, the mechanical layer 116 comprises a taut silicon-nitride film (SiNx), and flexibly supported above the surface 106 of the substrate 108 by a number of posts or structures, typically also made of SiNx, at both ends of the ribbon 102a. The conducting layer 112 can be formed over and in direct physical contact with the mechanical layer 116, as shown, or underneath the mechanical layer. The conducting layer 112 or ribbon electrode can include any suitable conducting or semiconducting material compatible with standard MEMS fabrication technologies. For example, the conducting layer 112 can include an amorphous or polycrystalline silicon (poly) layer, or a titanium-nitride (TiN) layer. Alternatively, if the reflective layer 118 is above the conductive layer 112, the conductive layer could also be metallic.

The separate, discrete reflecting layer 118, where included, can include any suitable metallic, dielectric or semiconducting material compatible with standard MEMS fabrication technologies, and capable of being patterned using standard lithographic techniques to form the reflective surface 104.

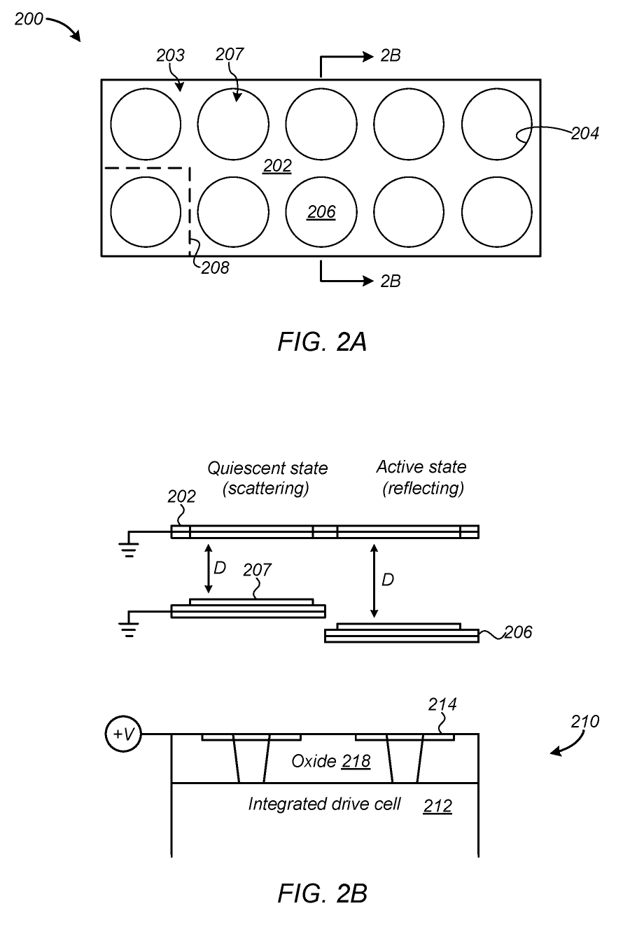

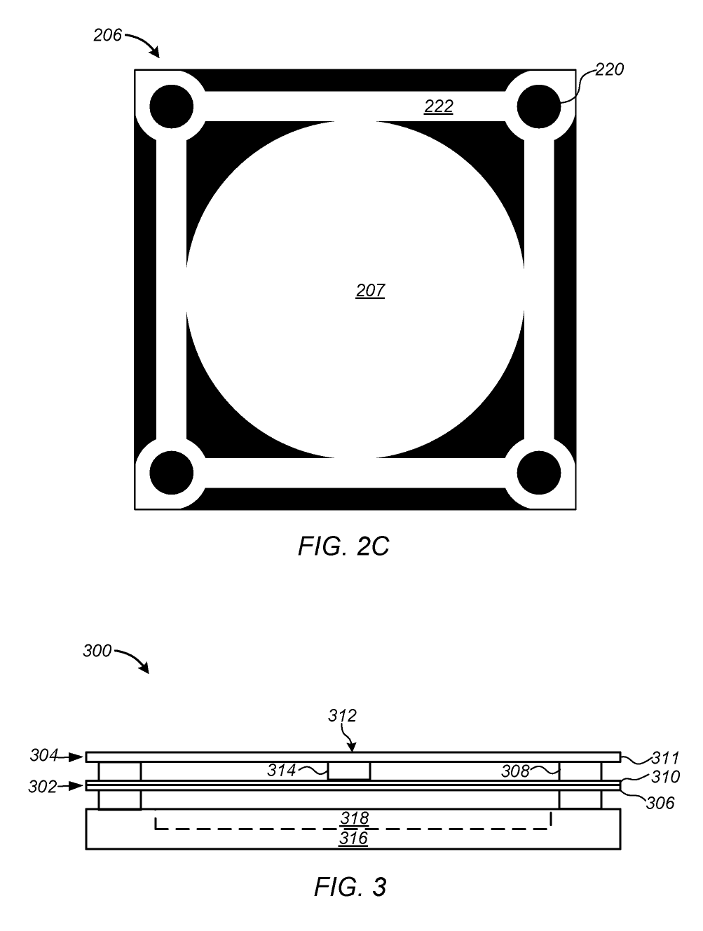

Another type of MEMS based optical modulator for which the dielectric mirror of the present invention is particularly useful is a planar light valve or PLV™ from Silicon Light Machines, Inc., of Sunnyvale, Calif. Referring to FIGS. 2A through 2C, a planar type light valve or PLV™ 200 is a two dimensional (2D) MEMS based optical modulator, which generally includes two films or membranes having light reflecting surfaces of equal area and reflectivity disposed above an upper surface of a substrate (not shown in this figure). The topmost film is a static member or face plate 202 of a uniform, planar sheet of a material having a first planar light reflective dielectric reflector or mirror 203, for example taut silicon-nitride covered on a top surface with one or more layers of material reflective to at least some of the wavelengths of light incident thereon. The face plate 202 has an array of apertures 204 extending from the top dielectric mirror 203 of the member to a lower surface (not shown). The face plate 202 covers an actuator membrane underneath. The actuator membrane includes a number of flat, displaceable or movable actuators 206. The actuators 206 have second planar dielectric mirror or reflector 207 parallel to the first planar dielectric mirror 203 of the face plate 202 and positioned relative to the apertures 204 to receive light passing therethrough. Each of the actuators 206, the associated apertures 204 and a portion of the face plate 202 immediately adjacent to and enclosing the aperture form a single, individual modulator 208 or diffractor. The size and position of each of the apertures 204 are chosen to satisfy an “equal reflectivity” constraint. That is the area of the second dielectric mirror 207 exposed by a single aperture 204 inside is substantially equal to the reflectivity of the area of the individual modulator 208 outside the aperture 204.

FIG. 2B depicts a cross-section through two adjacent modulators 208 of the light valve 200 of FIG. 2A. In this exemplary embodiment, the upper face plate 202 remains static, while the lower actuator membrane or actuators 206 move under electrostatic forces from integrated electronics or drive circuitry in the substrate 210. The drive circuitry generally includes an integrated drive cell 212 coupled to substrate or drive electrodes 214 via interconnect 216. An oxide 218 may be used to electrically isolate the electrodes 214. The drive circuitry is configured to generate an electrostatic force between each electrode 214 and its corresponding actuator 206.

Individual actuators 206 or groups of actuators are moved up or down over a very small distance (typically only a fraction of the wavelength of light incident on the light valve 200) relative to first planar dielectric mirror 203 of the face plate 202 by electrostatic forces controlled by drive electrodes 214 in the substrate 210 underlying the actuators 206. Preferably, the actuators 206 can be displaced by n*λ/4 wavelength, where λ is a particular wavelength of light incident on the first and second planar dielectric mirrors 203, 207, and n is an integer equal to or greater than 0. Moving the actuators 206 brings reflected light from the second planar dielectric mirror 207 into constructive or destructive interference with light reflected by the first planar dielectric mirror 203 (i.e., the face plate 202), thereby modulating light incident on the light valve 200.

For example, in one embodiment of the light valve 200 shown in FIG. 2B, the distance (D) between reflective layers of the tent 202 and actuator 206 may be chosen such that, in a non-deflected or quiescent state, the face plate, or more accurately the first dielectric mirror 203, and the actuator (second dielectric mirror 207), are displaced from one another by an odd multiple of λ/4, for a particular wavelength λ, of light incident on the light valve 200. This causes the light valve 200 in the quiescent state to scatter incident light, as illustrated by the left actuator of FIG. 2B. In an active state for the light valve 200, as illustrated by the right actuator of FIG. 2B, the actuator 206 may be displaced such that the distance between the dielectric mirrors 203, 207 of the face plate 202 and the actuator 206 is an even multiple of λ/4 causing the light valve 200 to reflect incident light.

In an alternative embodiment, not shown, the distance (D) between reflective layers of the tent 202 and actuator 206 can be chosen such that, in the actuator's quiescent state, the first and second dielectric mirrors 203, 207 are displaced from one another by an even multiple of λ/4, such that the light valve 200 in quiescent state is reflecting, and in an active state, as illustrated by the right actuator, the actuator is displaced by an odd multiple of λ/4 causing it to scatter incident light.

The size and position of each of the apertures 204 are predetermined to satisfy the “equal reflectivity” constraint. That is the reflectivity of the area of a single aperture 204 inside is equal to the reflectivity of the remaining area of the cell that is outside the aperture 204.

A close up planar view of a single actuator is shown in FIG. 2C. Referring to FIG. 2C, the actuator 206 is anchored or posted to the underlying substrate (not shown in this figure) by a number of posts 220 at the corner of each actuator. The actuators 208 include uniform, planar disks each having a planar dielectric mirror 207 and flexibly coupled by hinges or flexures 222 of an elastic material to one or more of the posts 220.

Although the light reflective surface of the actuator 206 is shown and described above as being positioned below the light reflective surface 203 of the face plate 202 and above the upper surface of the substrate, it will be appreciated that the dielectric mirror 207 of the actuator can alternatively be raised above the movable actuator so as to be positioned coplanar with or above the light reflective surface 203 of the face plate 202.

A schematic block diagram of a sectional side view of a single modulator 300 in an alternative embodiment of the MEMS or PLV is shown in FIG. 3. Referring to FIG. 3, the modulator 300 includes an actuator 302 and a separate dielectric mirror 304 spaced apart from the actuator. The actuator 302 includes a mechanical layer 306 of an elastic material, such as silicon-nitride (SiN), which flexibly couples the actuator to one or more posts 308, and an electrically conductive layer 310 of a conductive material, such as a titanium-nitride (TiN). The dielectric mirror 304 includes a taut layer of an elastic material 311, such as SiN, having a reflective surface 312 formed thereon and is supported at the corners of the individual modulator by posts 308. The dielectric mirror 304 is decoupled or mechanically isolated from the actuator 302 by a center support 314 and the posts 308. The actuator 302 and dielectric mirror 304 are supported above a surface of a substrate 316 having a base electrode 318 formed in or on a surface thereof. As in in the embodiments described above, the actuator 302, and the dielectric mirror 304 coupled thereto through the center support 314, are deflected towards the surface of the substrate 316 by electrostatic forces generated by a voltage applied between the electrically conductive layer 310 of the actuator and the base electrode 318.

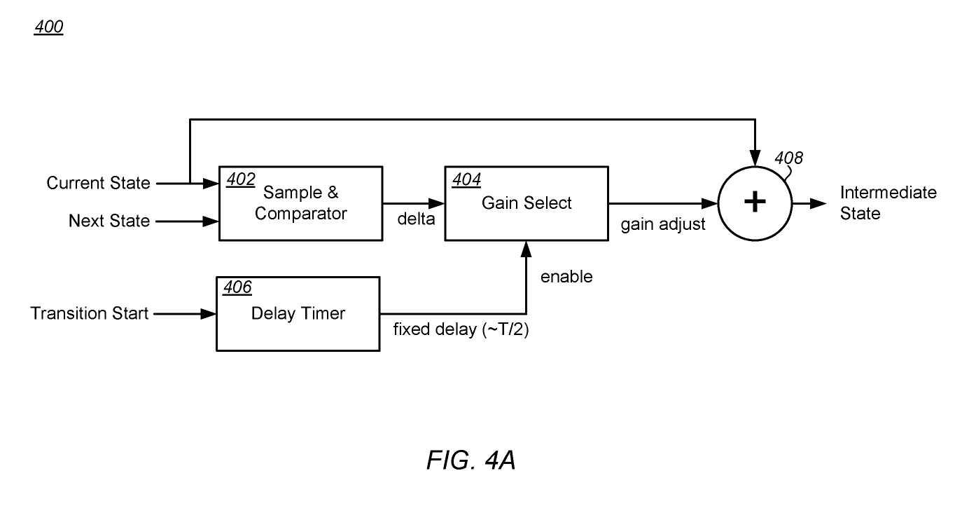

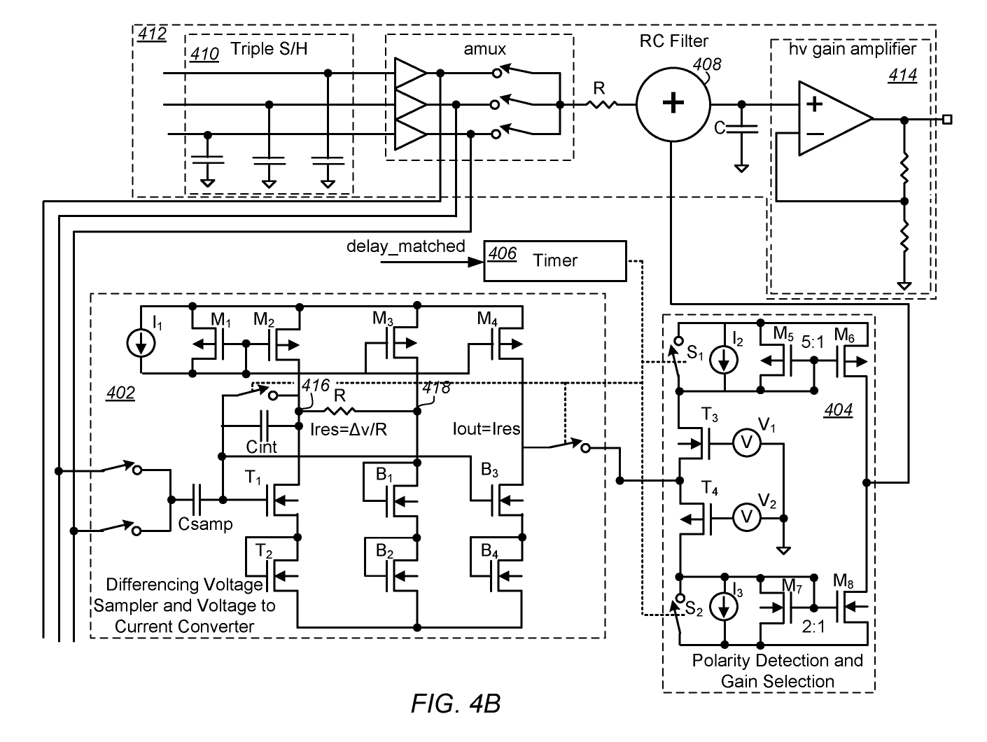

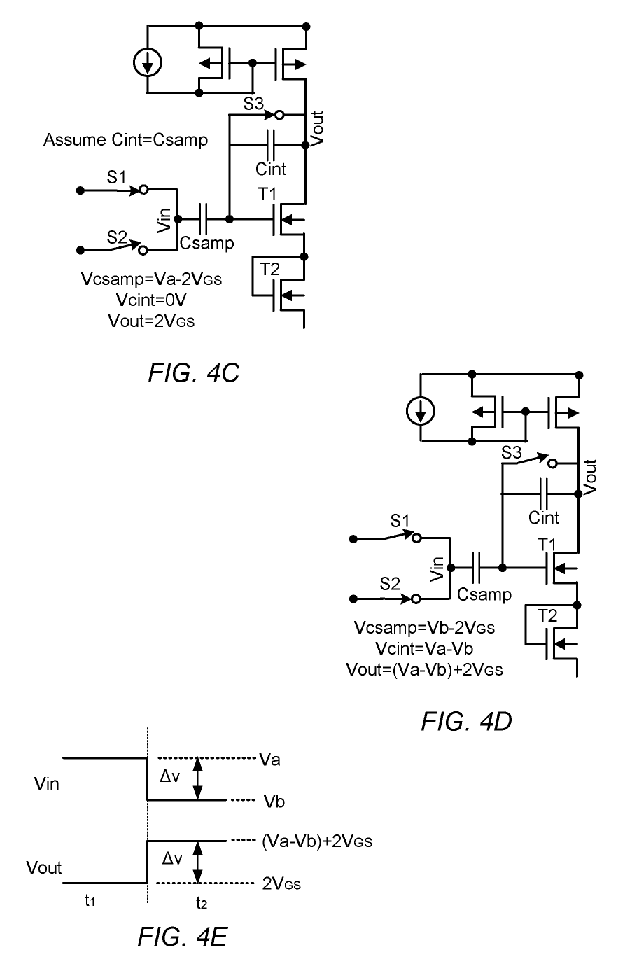

FIG. 4A is a block diagram of a pulse shaping circuit according to an embodiment of the present disclosure. Referring to FIG. 4A the circuit 400 generally includes a sample and comparator sub-circuit 402, a gain selection sub-circuit 404, a delay timer sub-circuit 406 and a summing sub-circuit 408. The sample and comparator sub-circuit 402 samples and compares a voltage of a current state and next state of an input pulse from a drive circuit (not shown in this figure), and outputs a signal (delta) representing a magnitude and polarity of a transition from the current state to the next state. The delta signal is coupled to the gain selection sub-circuit 404, which determines the amplitude of the gain adjustment desired for the intermediate state. The delay timer sub-circuit 406 generates a fixed delay relative to the transition start. In one embodiment, such as that shown in this figure, the delay timer sub-circuit 406 generates a fixed delay signal indicating a fixed delay equal to approximately one half (½) of a resonant period of the movable element of the MEMs being driven. The fixed delay signal is coupled to the gain selection sub-circuit 404, which then generates a gain adjust signal incorporating the fixed delay signal. The gain adjust signal and the current drive are summed in the summing sub-circuit 408 to produce an intermediate state signal.

FIG. 4B is a schematic diagram of an embodiment of the pulse shaping circuit of FIG. 4A. Referring to FIG. 4B, the sample and comparator sub-circuit 402 receives the current and next state voltages from a triple sample and hold (S/H) sub-circuit 410 in a drive circuit 412. Generally, the sample and comparator sub-circuit 402 includes a current circuit including current source (I₁) and transistors M₁ to M₄, and an amplifier including a sampling capacitor (Csamp), an integrating capacitor (Cint), a transistor (T₁) to sample and determine an average voltage of the current and next drive state voltage, and a biasing transistor (T₂) to provide a positive offset voltage to the amplifier. The sub-circuit 402 further includes a load resistance (R) to convert the difference in voltage output by the amplifier to a current, and additional biasing transistors B₁ and B₂ in the current path of the output of the amplifier, and B₃ and B₄ in the current path of the output for the circuit (Iout).

The sample and comparator sub-circuit 402 determines average voltage of the current and next drive state voltage by sampling sequentially and applies that voltage to a first node 416 coupled to the resistor R resulting in voltage drop (ΔV) across the resistor and a current (Ires). Given that Id(M2) and Id(M4) are equal, and that Vg(T1) and Vg(B3) are also equal, the current (Ires) is replicated as a current signal in a replication leg (M₄, B₃ and B₄). The current signal is output to the gain selection sub-circuit 404. Operation of the sample and comparator sub-circuit 402 will be described in greater detail below with reference to FIGS. 4C and 4D.

The gain selection sub-circuit 404 takes the output current from the comparator sub-circuit 402 (Iout) and generates an adjustment current (Iadjust) of appropriate polarity and magnitude. Generally, the gain selection sub-circuit 404 includes a first current adjusting circuit formed by current source (I₂), transistor T₃, voltage source V1 and a current mirror formed by M₅ and M₆, and a second current biasing circuit formed by current source (I₃), transistor T₄, voltage source V2 and a current mirror formed by M₇ and M₈. In operation, when the current signal from sample and comparator sub-circuit 402 is decreasing, that is the voltage of the next drive state is less than the current drive state that is on the trailing or falling edge of the drive pulse, the output current lout is a sinking current so transistor T₃ turns on the and first current adjusting circuit acts as current sink. This in turn draws current away from the summing sub-circuit 408 coupled to the output of the gain selection sub-circuit 404, generating an anti-pulse that is added to the voltage of the current drive state, decreasing the voltage to an intermediate voltage between the current and next drive voltage. Similarly, voltage of V2 is selected so that in operation when the current signal from sample and comparator sub-circuit 402 is increasing, that is the voltage of the next drive state is greater than the current drive state or the leading edge of the drive pulse, the output current Iout is a sourcing current so transistor T₄ turns on the and first current biasing circuit acts as current source, sending additional current to the summing sub-circuit 408, generating a pulse that is added to the voltage of the current drive state, increasing the voltage to an intermediate voltage between the current and next drive voltage. Current Sources I2 and I3 provide for a minimum threshold value, where |Iout| must be greater than |I2| or |I3| for any effect to occur. V1 and V2 provide a bias to reduce the voltage swing at the node connected to the sources of T3 and T4. The sum of V1 and V2 must be <the sum of the V_{T} of T3 and T4 to prevent any quiescent current flow.

The ratios current mirrors selected are empirically determined, based on desired intermediate amplitude ratios. In the embodiment shown in FIG. 4B, the current mirror in the first adjustment circuit formed by transistors M₅ and M₆ have a ratio of 5:1 to so that the offset on the falling edge is 20% of full scale change in the pulse amplitude. Similarly, the current mirror in the second adjustment circuit formed by transistors M₇ and M₈ have a ratio of 2:1 to so that the offset on the rising edge is 50% of full scale change in the pulse amplitude.

As described above a fixed delay signal is coupled to the gain selection sub-circuit 404, when a time equal to the predetermined fixed delay has elapsed or been matched. The gain selection sub-circuit 404 then generates a gain adjust signal incorporating the fixed delay signal, which is coupled to the summing sub-circuit 408. The current state is also coupled through a multiplexor (amux) and a resistor (R) of an RC filter to the summing sub-circuit 408, and summed to produce an intermediate state signal. The current of intermediate state signal is then converted back to a voltage by capacitor (C) of the RC filter and coupled to a HV gain amplifier 414 in the drive circuit 412 to drive one or more electrodes in the MEMS.

As described above, the delay timer sub-circuit 406 generates a fixed delay signal that is coupled to switches in the comparator sub-circuit 402 and the gain selection sub-circuit 404, when a time equal to the predetermined fixed delay has elapsed or been matched. The gain selection sub-circuit 404 then generates a gain adjust signal incorporating the fixed delay signal, which is coupled to the summing sub-circuit 408. The current state is also coupled through a multiplexor (amux) and a resistor (R) of an RC filter to the summing sub-circuit 408, and summed to produce an intermediate state signal. The output of the RC filter is coupled to a HV gain amplifier 414 in the drive circuit 412 to drive one or more electrodes in the MEMS.

Operation of the sample and comparator sub-circuit 402 will now be described in greater detail with reference to FIGS. 4C through 4E. FIGS. 4C and 4D are schematic diagrams of a portion of the sample and comparator of the pulse shaping circuit of FIG. 4B illustrating different configurations during the voltage sampling operation. FIG. 4E are graphs of input pulse and an output pulse from the sample comparator of FIGS. 4C and 4D. Referring to FIG. 4C, at a first time (t₁ in FIG. 4E) a voltage (Va) of the current state signal is coupled through switch (S1) to the sampling capacitor (Csamp) to sample the current state voltage. Also at this time, switch (S3) is closed discharging integration capacitor (Cint). Thus, as shown in FIG. 4E at this first time (t₁) Vin equals Va, Vout equals the voltage drop across T1 and FT2, or about 2V_{Gs}, and a voltage (Vcsamp) across the sampling capacitor equals Va −2V_{Gs}.

Next, referring to FIG. 4E, at a second time (t₂ in FIG. 4E) a voltage (Vb) of the next state signal is coupled through switch (S2) to the sampling capacitor (Csamp) to sample the next state voltage. Switch S3 will open allowing the voltage (Vcsamp) across the integration capacitor to rise to a difference between Vb and 2V_{Gs}. Thus, as shown in FIG. 4E at this second time (t₂) Vin equals Vb, and Vout will change to proportional to a difference between the current and next state voltages, or Va and Vb, and is equal to (Va−Vb)+2V_{Gs}.

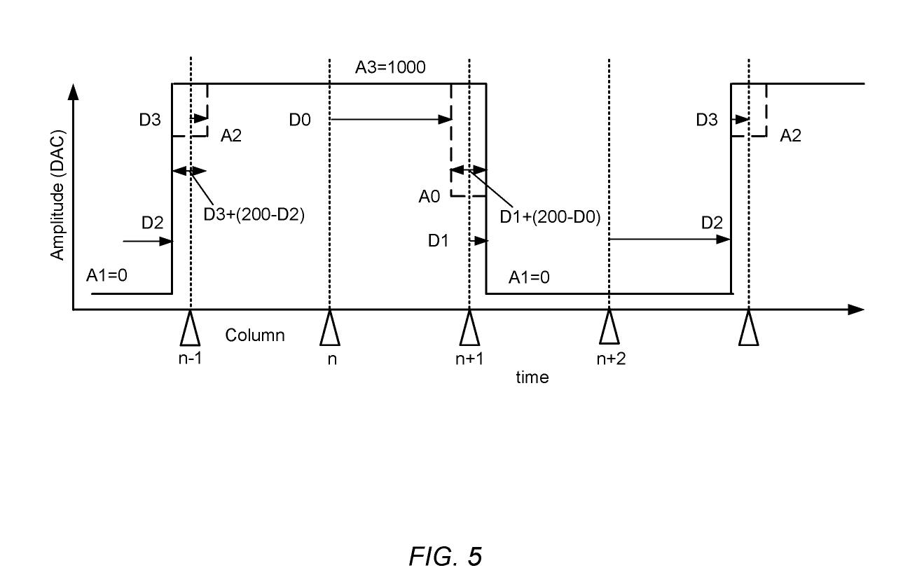

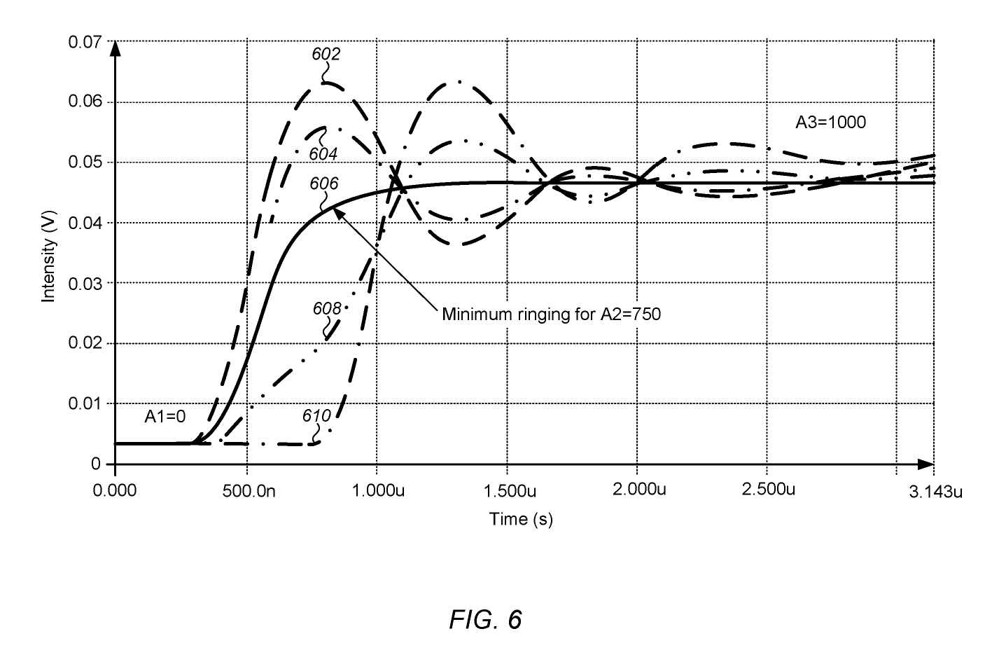

FIG. 5 is an idealized graph of a test pulse from a driver or digital-to-analog converter (DAC) used in a test used for determining an optimal step amplitude or magnitude and step delay in an optimized shaped pulse according to an embodiment of the present disclosure. Referring to FIG. 5, the test pulse has four amplitudes (A0-A3) and four delays (D0-D3). The four amplitudes include an initial voltage or amplitude A1, here normalized to a value of 0, a maximum voltage or amplitude A3, here normalized to a value of 1000, a rising edge step voltage or amplitude, A2, intermediate between A1 and A3, and a falling edge step voltage or amplitude, A0, also intermediate between A1 and A3. For reasons that are explained in greater below in connection with FIGS. 6 through 9, the falling edge step voltage or amplitude, A0, is generally less than the rising edge step voltage or amplitude, A2.

Optimization of the pulse shaping parameters was carried out using a MEMS driver with programmable delay. With reference to FIG. 5, elapsed time is divided into a series of “column” periods separated by column “strobes”. The programmable delay capability of the driver allows a voltage transition to be placed anywhere within the column. Each column incorporates a single delay value (Di) which represents the elapsed time between the amplitude transition and the previous column strobe. The delay resolution is 1/200^{th} of the column period (i.e. 20 ns resolution in a 4 us column period). The diagram shows D0, between a first column strobe (n) and a falling edge step of the pulse, a delay, D1, between a second column (n+1) and a final falling edge of the pulse, a delay, D2, between a third column (n+2) and a beginning or initial rising edge of the pulse, and a delay between a column (n−1) and a rising edge step. Parameters varied for the test pulse to determine an optimal step amplitude or magnitude and step delay include the rising edge step amplitude, A2, a first or rising edge step delay, equal to (D3−D2)+200 nanoseconds (ns), the falling edge step amplitude, A0, a second or falling edge step delay, equal to (D1−D)+200 ns.

FIG. 6 is a graph illustrating an intensity of reflection from a movable element in an electrostatic MEMS based optical modulator driven by test pulses with various rising edge step amplitudes, A2, to determine an optimal value for A2. For this test an electrostatic MEMS based optical modulator having a movable element with a resonant period of about 1 μs or a resonant frequency of about 1.0 MHz and full amplitude swing or maximum voltage of 20 VDC applied to an electrode in the movable element, was illuminated with a coherent light source. The intensity of the reflected light was measured over time using a silicon photo-diode which converts the incident light into a proportional voltage. The duration of the rising edge step delay was fixed at 25 counts or about 500 nanoseconds (ns).

Referring to FIG. 6, maximum voltage or amplitude A3 is normalized to a value of 1000. Line 602 illustrates the effect on ringing for a value of A2=1000 or 100% of the maximum voltage—essentially no rising edge step. Line 604 illustrates the effect on ringing for a value of A2=900 or 90% of the maximum voltage and shows a marked improvement over the pulse where A2=1000. Line 606 illustrates the effect on ringing for a value of A2=750 or 75% of the maximum voltage and illustrates the optimal value for A2 wherein ringing is substantially eliminated. Line 608 illustrates the effect on ringing for a value of A2=500 or 50% of the maximum voltage, and Line 610 illustrates the effect on ringing for a value of A2=100 or 10% of the maximum voltage.

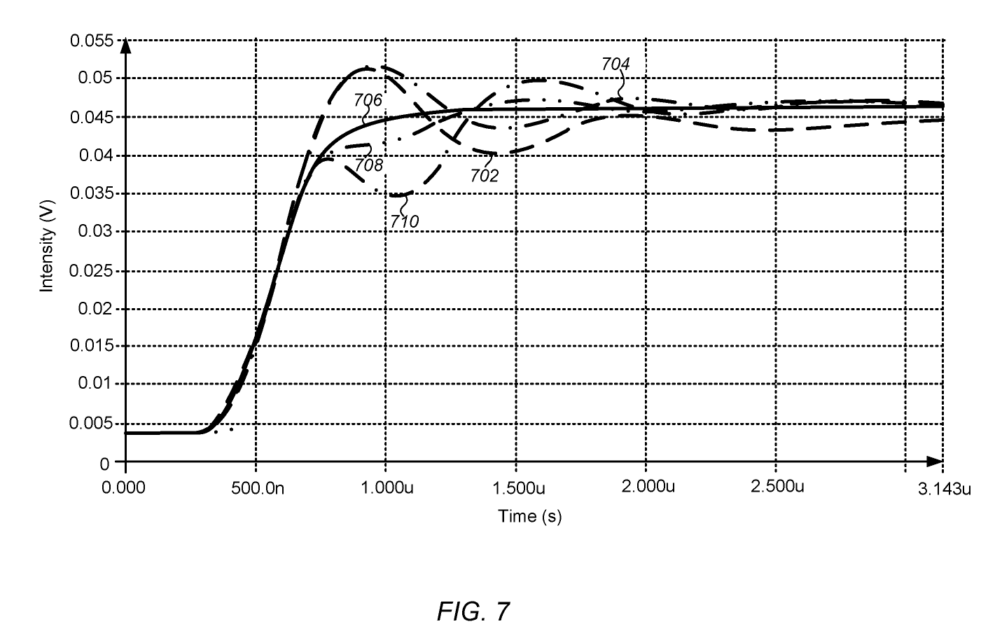

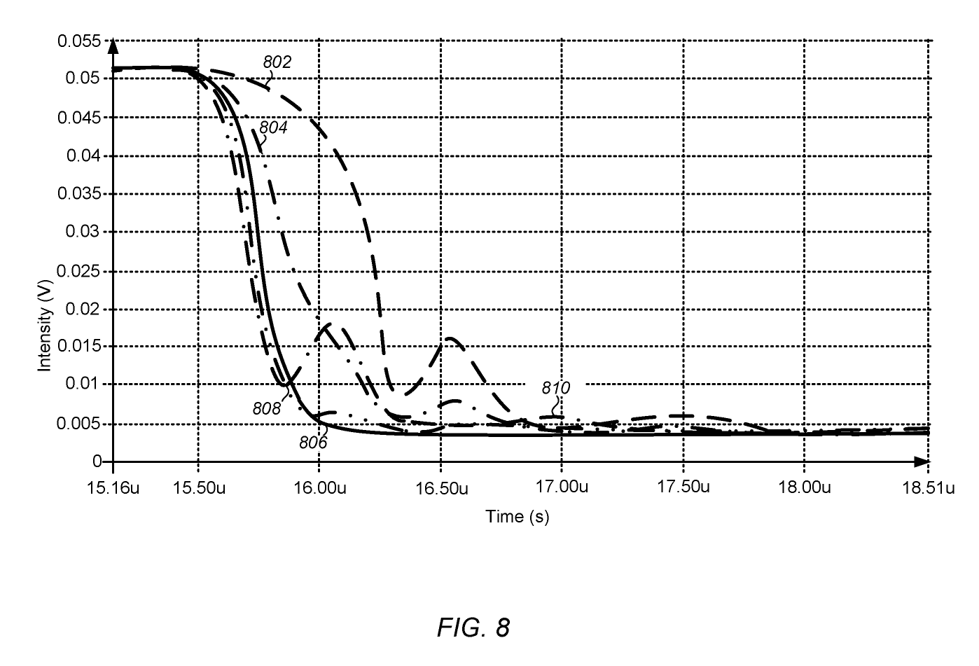

FIG. 7 is a graph illustrating an intensity of reflection from a movable element in an electrostatic MEMS based optical modulator driven by test pulses with various rising edge step delays to determine an optimal duration for this delay. As with the previous test described in connection with FIG. 6 for this test a MEMS with a resonant period of about 1 μs and a maximum voltage swing of 20 VDC was illuminated with a coherent light source. The rising edge step amplitude, A2, was fixed at a value of A2=750 or 75% of the maximum voltage or about 15 VDC. As described in connection with FIG. 5 the rising edge step delay is equal to (D3−D2)+200 ns. Thus, for this series of tests D2 was held to a fixed value of 185 counts or delay steps while D3 was swept from 2-18 counts.

Referring to FIG. 7, line 702 illustrates the effect on ringing for a value of D3=2. Line 704 illustrates the effect on ringing for a value of D3=4. Line 706 illustrates the effect on ringing for a value of D3=8.Line 708 illustrates the effect on ringing for a value of D3=12. Line 710 illustrates the effect on ringing for a value of D3=18.Line 706 illustrates the effect on ringing for a value of D3=8 or 460 ns wherein ringing is substantially eliminated with minimal damping.

FIG. 8 is a graph illustrating an intensity of reflection from a movable element in an electrostatic MEMS based optical modulator driven by test pulses with various falling edge step amplitudes, A0, to determine an optimal value for A0. As with the previous test described in connection with FIG. 6 for this test a MEMS with a resonant period of about 1 μs and a maximum voltage of 20 VDC was illuminated with a coherent light source. The duration of the falling edge step delay was fixed at 25 counts or about 500 nanoseconds (ns).

Referring to FIG. 8, the maximum voltage or amplitude A3 is normalized to a value of 1000. Line 802 illustrates the effect on ringing for a value of A0=1000 or 100% of the maximum voltage—essentially no falling edge step. Line 804 illustrates the effect on ringing for a value of A0=750 or 75% of the maximum voltage. Line 806 illustrates the effect on ringing for a value of A0=450 or 45% of the maximum voltage and illustrates the optimal value for AO wherein ringing is substantially eliminated. Line 808 illustrates the effect on ringing for a value of A0=300 or 30% of the maximum voltage, and Line 810 illustrates the effect on ringing for a value of A0=100 or 10% of the maximum voltage.

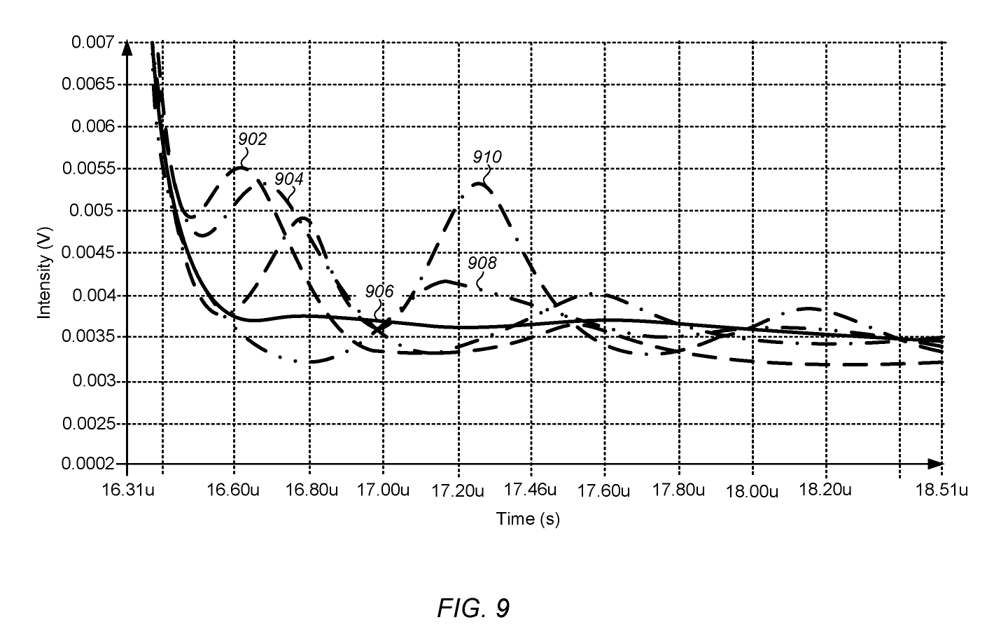

FIG. 9 is a graph illustrating an intensity of reflection from a movable element in an electrostatic MEMS based optical modulator driven by test pulses with various falling edge step delays to determine an optimal duration for this delay. As with the previous test described in connection with FIG. 7 for this test a MEMS with a resonant period of about 1 μs and a maximum voltage of 20 VDC was illuminated with a coherent light source. The falling edge step amplitude, A0, was fixed at a value of A0=450 or 45% of the maximum voltage or about 9 VDC. As described in connection with FIG. 5 the falling edge step delay is equal to (D1−D0)+200 ns. Thus, for this series of tests D0 was held to a fixed value of 185 counts or delay steps while D1 was swept from 2-18 counts.

Referring to FIG. 9, line 902 illustrates the effect on ringing for a value of D1=2. Line 904 illustrates the effect on ringing for a value of D3=4. Line 906 illustrates the effect on ringing for a value of D1=8.Line 908 illustrates the effect on ringing for a value of D1=12. Line 910 illustrates the effect on ringing for a value of D1=18.Line 906 illustrates the effect on ringing for a value of D1=8 or 460 ns wherein ringing is substantially eliminated with minimal damping.

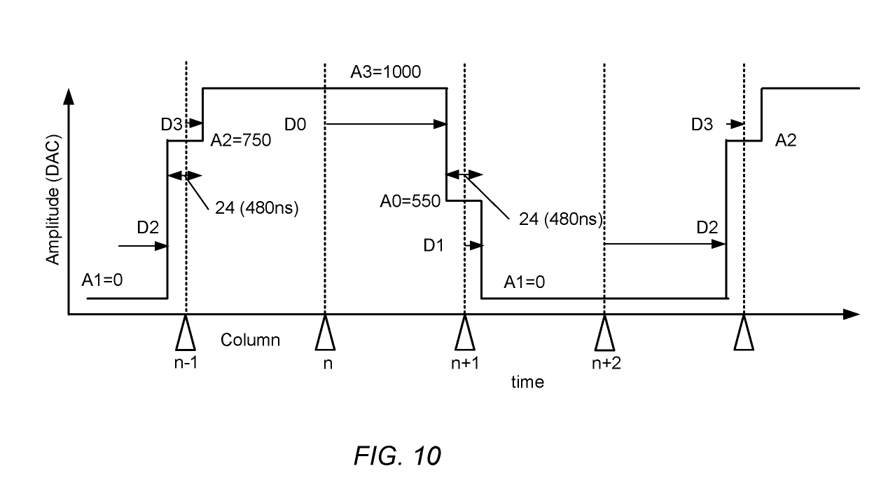

FIG. 10 is an idealized graph of an optimized shaped pulse according to an embodiment of the present disclosure derived from the above described tests and graphs. Referring to FIG. 10, for a MEMS having a movable element with a resonant period of about 1 μs and a full amplitude swing or maximum voltage of 20 volts DC, the rising edge step amplitude, A2, is optimized at about 75% of the full swing voltage or about 15 V, the falling edge step amplitude, A0, is optimized at about 55% of the full swing voltage or about 11 V, and the first or rising edge step delay, and the second or falling edge step delay, are substantially identical and optimized to about 24 counts or 480 ns, which is about the expected value defined by ½ resonant frequency (1/(2*480 ns)=1.05 MHz.

It will be understood that while the method described above for optimizing a shaped pulse has been described with reference to an electrostatic MEMS based optical modulator having a movable element with a resonant period of about 1 μs, the method can be applied to any electrostatic MEMS having a movable element with a known resonant period without departing from the scope of the present invention.

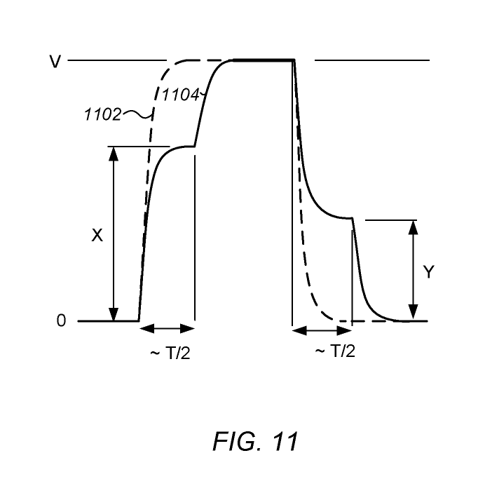

FIG. 11 is a graph of an optimized shaped voltage pulse according to an embodiment of the present disclosure compared to a conventional or non-shaped voltage pulse. Referring to FIG. 11, it is seen that the conventional, or non-shaped voltage pulse, represented by dashed line 1102, has a rising edge that quickly and monotonically increases from an initial voltage (0) to a maximum voltage (V) that is maintained for the pulse duration before quickly and monotonically decreasing on a falling edge back to the initial voltage of 0V.

In contrast, the shaped voltage pulse, represented by solid line 1104, has a rising and a falling edge with intermediate voltage amplitudes and delays optimized to substantially eliminate ringing in a movable element, such as a ribbon or actuator, of an electrostatic MEMS driven by the optimized shaped voltage pulse. In particular referring to FIG. 11 it is seen that beginning at the same time as the conventional, non-shaped voltage pulse 1102, the shaped voltage pulse 1104 has a rising edge in which the voltage rises to a first intermediate voltage or amplitude (X) between the initial voltage (0) and maximum voltage (V) where it is held or delayed for a first delay time equal to approximately one half (½) a resonant period (T) of the movable element driven by the optimized shaped voltage pulse before rising again to the maximum voltage (V). The voltage of the optimized shaped pulse is maintained at the maximum voltage (V) for the pulse duration minus the first delay time, decreasing on a falling edge to a second intermediate voltage or amplitude (V-Y) where it is held or delayed for a second delay time before falling edge back to the initial voltage of 0V. Preferably, as in the embodiment shown the second delay time is equal to the first delay time, or about one half (½) the resonant period (T) of the movable element. It is noted that the first intermediate voltage and the second intermediate voltage need not, and in the embodiment illustrated are not equal. Rather, the first intermediate voltage is a selected voltage between 25% and 95% of the maximum voltage (V), and more preferably about 75% of the full swing or maximum voltage (V), while the second intermediate voltage is a selected voltage between 5% and 75%), and more preferably about 45% of the maximum voltage (V).

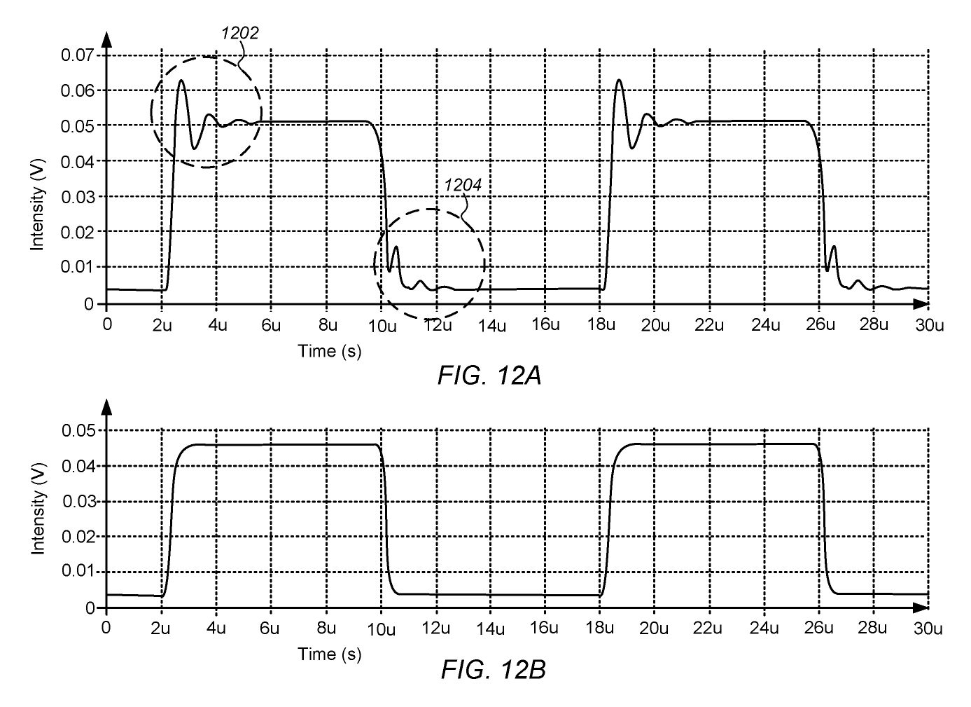

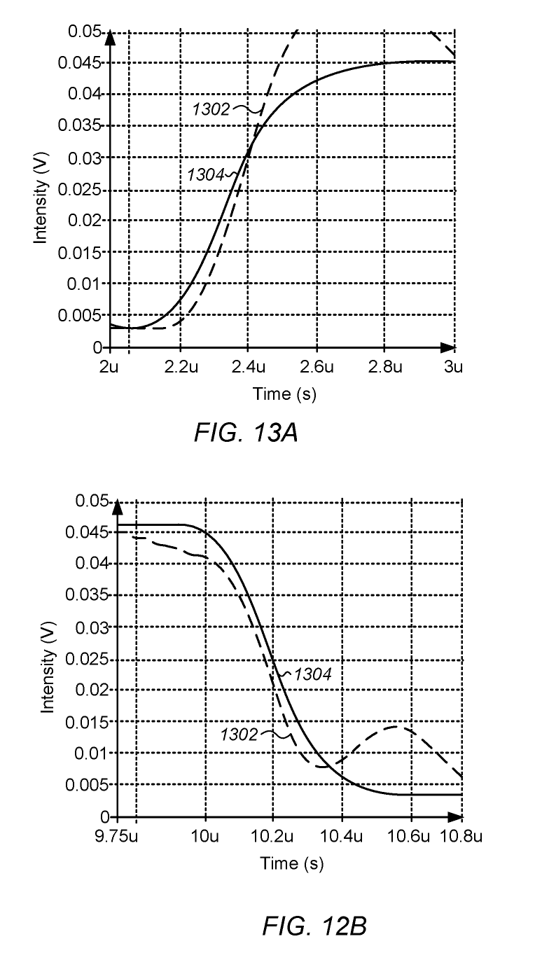

FIGS. 12A and 12B are graphs comparing an intensity of reflection from a movable element in an electrostatic MEMS based optical modulator driven by an optimized shaped pulse versus a non-shaped pulse. Referring to FIG. 12A it is seen that an intensity of light reflected from a movable element, such as a ribbon or actuator, of an electrostatic MEMS driven by a conventional or non-shaped voltage pulse exhibits on a rising edge of the reflected light fluctuations, indicated by dashed circle 1202 of up to about 0.02 V that can last for up to about 4 microseconds (μs). Similarly, the falling edge of the reflected light can exhibit fluctuations, indicated by dashed circle 1204 of up to about 0.01 V lasting for from about 2 to about 3 μs.

In contrast, referring to FIG. 12B the same electrostatic MEMS driven by a shaped voltage pulse having a rising and a falling edge with intermediate voltage amplitudes and delays optimized to substantially eliminate ringing in the movable element(s) exhibit substantially fluctuations in the reflected light on either the rising or falling edge of the reflected light, significantly improving optical response and resolution of the MEMS.

FIGS. 13A and 13B are graphs illustrating the effects on rise and fall time, respectively, of light reflected from an optical MEMS driven by an optimized shaped voltage pulse according to an embodiment of the present disclosure compared to a conventional or non-shaped voltage pulse. The times of light reflected from an optical MEMS driven by a conventional or non-shaped pulse are represented by dashed line 1302 and the times of light reflected from the optical MEMS driven by an optimized shaped voltage are represented by solid line 1304.

Referring to FIG. 13A, it is seen that despite a first intermediate voltage and first delay optimized shaped voltage pulse, illustrated for example in FIG. 11, the rise time of light reflected from the optical MEMS when driven by an optimized shaped voltage pulse is substantially the same as or better than the rise time when driven by a conventional or non-shaped pulse. In particular, the intensity of the reflected light begins for both the a conventional and optimized shaped pulse at an intensity of about 0.0025 V at time of 2 μs. However, the light reflected from the optical MEMS driven by the optimized shaped voltage, represented by solid line 1304, has reached and settled at a desired maximum intensity of about 0.045 V at time of 2.8 μs, while the light reflected optical MEMS driven by the conventional or non-shaped voltage, represented by dashed line 1302, has overshot the desired maximum intensity, only intersecting the desired maximum intensity briefly at about 2.5 μs, and likely taking far longer than the 3 μs illustrated in this graph before settling at the desired maximum intensity of about 0.045 V.

Referring to FIG. 13B, it is seen that despite a second intermediate voltage and second delay optimized shaped voltage pulse, illustrated for example in FIG. 11, the fall time of light reflected from the optical MEMS when driven by an optimized shaped voltage pulse is substantially better than the fall time when driven by a conventional or non-shaped pulse. In particular, the intensity of the reflected light begins for both the conventional and optimized shaped pulse at the desired maximum intensity of about 0.045 at time of 9.7 μs. However, the light reflected from the optical MEMS driven by the optimized shaped voltage, represented by solid line 1304, has fallen to and settled at an initial intensity of about 0.0025 V at time of about 10.5 μs., while the light reflected optical MEMS driven by the conventional or non-shaped voltage, represented by dashed line 1302, continues to fluctuate and has still not fallen to and settled at the initial intensity of about 0.0025 V by the last time illustrated in this graph time of 10.8 μs.

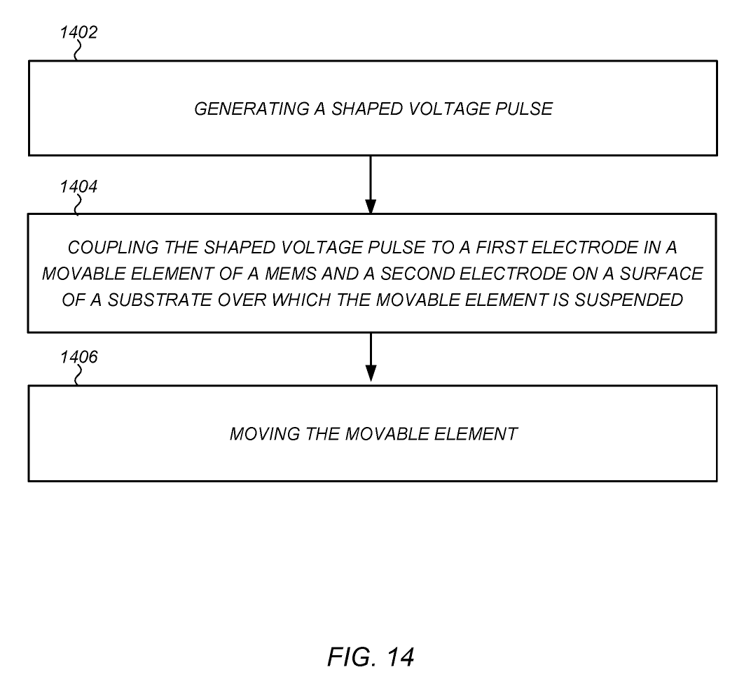

A method for driving electrostatic MEMS using a shaped pulse according to an embodiment of the present disclosure will now be described with reference to the flowchart of FIG. 14. Referring to FIG. 14, the method begins with generating a shaped voltage pulse (1402). Next, the shaped voltage pulse is coupled to a first electrode in a movable element of a MEMS and a second electrode on a surface of a substrate of the MEMS over which the movable element is suspended (1404). The movable element is then moved by an electrostatic force generated between the first and second electrodes by a voltage differential introduced by the shaped voltage pulse (1406).

As described above, the shaped pulse has a leading edge in which a first intermediate voltage between an initial, minimum voltage and a maximum voltage is maintained for a first time before rising to the maximum voltage. Preferably, the first time for which the first intermediate voltage is maintained is equal to about ½ a resonant period of the movable element and the first intermediate voltage is between about 25% and 95% of the maximum voltage. In certain embodiments, generating the shaped voltage pulse further includes generating a shaped voltage pulse having a trailing edge in which a second intermediate voltage between the maximum voltage and the minimum voltage is maintained for a second time before falling to the minimum voltage. In some of these embodiments, the second intermediate voltage is between 5% and 75% of the maximum voltage, and the second time for which the second intermediate voltage is maintained is substantially the same as the first time.

Thus, embodiments of a circuit and method for driving an optical MEMS have been described. Although the present disclosure has been described with reference to specific exemplary embodiments, it will be evident that various modifications and changes may be made to these embodiments without departing from the broader spirit and scope of the disclosure. In particular, it is noted the circuit and method of the present disclosure can apply in principle to any electrostatic MEMS. Accordingly, the specification and drawings are to be regarded in an illustrative rather than a restrictive sense.

The Abstract of the Disclosure is provided to comply with 37 C.F.R. §1.72(b), requiring an abstract that will allow the reader to quickly ascertain the nature of one or more embodiments of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

Reference in the description to one embodiment or an embodiment means that a particular feature, structure, or characteristic described in connection with the embodiment is included in at least one embodiment of the circuit or method. The appearances of the phrase one embodiment in various places in the specification do not necessarily all refer to the same embodiment.

What is claimed is:

1. A circuit for driving a MEMS comprising:
a first electrode in a movable element of the MEMS and a second electrode on a surface of a substrate of the MEMS over which the movable element is suspended;
a driver electrically coupled to the first and the second electrodes to supply a voltage differential between the first and second electrodes to vary an electrostatic force between the electrodes thereby moving the movable element,
wherein the driver is configured to supply a voltage pulse having a leading edge in which a first intermediate voltage between an initial, minimum voltage and a maximum voltage is maintained for a first time before rising to the maximum voltage timed to dampen oscillations of the movable element.

2. The circuit of claim 1, wherein the first time is approximately ½ a resonant period of the movable element.

3. The circuit of claim 1, wherein the first intermediate voltage is between 25% and 95% of the maximum voltage.

4. The circuit of claim 1, wherein the voltage pulse further comprises trailing edge in which a second intermediate voltage between the maximum voltage and the minimum voltage is maintained for a second time before falling to the minimum voltage.

5. The circuit of claim 5, wherein the second intermediate voltage is between 5% and 75% of the maximum voltage.

6. The circuit of claim 4, wherein the second time is substantially the same as the first time.

7. The circuit of claim 6, wherein the second time is approximately ½ a resonant period of the movable element.

8. A microelectromechanical systems (MEMS) comprising:
a substrate including a substrate electrode proximal to a surface thereof;
a movable element including an element electrode suspended over the surface of the substrate;
a driver electrically coupled to the first and the second electrodes to supply a voltage differential between the substrate and element electrodes to vary an electrostatic force between the electrodes thereby moving the movable element,
wherein the driver is configured to supply a voltage pulse having a leading edge in which a first intermediate voltage between an initial, minimum voltage and a maximum voltage is maintained for a first time before rising to the maximum voltage timed to dampen oscillations of the movable element.

9. The MEMS of claim 8, wherein the first time is approximately ½ a resonant period of the movable element.

10. The MEMS of claim 9, wherein the first intermediate voltage is between 25% and 95% of the maximum voltage.

11. The MEMS of claim 10, wherein the voltage pulse further comprises trailing edge in which a second intermediate voltage between the maximum voltage and the minimum voltage is maintained for a second time before falling to the minimum voltage, and wherein the second intermediate voltage is between 5% and 75% of the maximum voltage.

12. The MEMS of claim 11, wherein the second time is substantially the same as the first time.

13. The MEMS of claim 8, wherein the MEMS is an optical modulator comprising a number of ribbons, each including a reflective surface, and wherein the movable element includes at least one of the number of ribbons.

14. The MEMS of claim 8, wherein the MEMS is a two dimensional (2D) optical modulator, the movable element comprises a planar membrane having a light reflecting surface, and the 2D optical modulator further comprises a static member having a light reflecting surface overlying the planar membrane of the movable element and an aperture through which the reflective surface of the movable element is exposed.

16. A method comprising:
generating a voltage pulse having a leading edge in which a first intermediate voltage between an initial, minimum voltage and a maximum voltage is maintained for a first time before rising to the maximum voltage; and
coupling the voltage pulse to a first electrode in a movable element of a microelectromechanical systems (MEMS) and a second electrode on a surface of a substrate of the MEMS over which the movable element is suspended,
wherein a voltage differential between the first and second electrodes introduced by the voltage pulse varies an electrostatic force between the electrodes thereby moving the movable element.

17. The method of claim 16, wherein the first time is approximately ½ a resonant period of the movable element.

18. The method of claim 17, wherein the first intermediate voltage is between 25% and 95% of the maximum voltage.

19. The method of claim 18, wherein generating the voltage pulse further comprises generating a voltage pulse comprising a trailing edge in which a second intermediate voltage between the maximum voltage and the minimum voltage is maintained for a second time before falling to the minimum voltage, and wherein the second intermediate voltage is between 5% and 75% of the maximum voltage.

20. The method of claim 19, wherein the second time is substantially the same as the first time.
